(19) United States
(12) Patent Application Publication
(10) Pub. No.: US 2002/0196851 A1
(43) Pub. Date: Dec. 26, 2002

(54) Method of converting video data streams

(76) Inventor: Cedric Arnaud Lecoutre, Boussy Saint Leger (FR)

Correspondence Address: Corporate Patent Cousel, Philips Electronic North America Corporation, 580 White Plains Road, Tarrytown, NY, 10591, US

(21) Appl. No.: 10/129,493

(22) PCT Filed: Sep. 3, 2001
(86) PCT No.: PCT/EP01/10177

(30) Foreign Application Priority Data
Sep. 5, 2000 (FR) 0011308

(51) Int. Cl. H04N 7/12

(52) U.S. Cl. 375/240.12; 375/240.15

(57) ABSTRACT

The present invention relates to a method of converting a binary input stream of data endcoded in a accordance with a first format of a block encoding technique into a binary output stream of data encoded in accordance with a second format of the encoding technique. It has been developed more specifically within the scope of the conversion of a binary input stream endcoded in accordance with the MPEG 1 standard into a binary output stream encoded in accordance with the MPEG 4 standard.

Since the MPEG 4 standard does not allow intra macroblocks in a bidirectionally predictive-coded B picture, the conversion method in accordance with the invention comprises a step of replacing macroblocks of a B picture with predicted macroblocks.

### DESCRIPTION

The present invention relates to a method of converting a binary input stream of data encoded in accordance with a first format of a block based encoding technique, the binary input stream comprising pictures, into a binary output stream of data encoded in accordance with a second format of the encoding technique.

This conversion method can be applied to, for example, streams of binary data encoded in accordance with the MPEG ( acronym for “Moving Pictures Experts Group) encoding technique in order to convert a binary stream encoded in accordance with a first format of the MPEG standard into a stream of binary data encoded in accordance with a second format of this standard.

Currently, there are several MPEG formats that have been standardized. These are the standards:

MPEG-1 (bearing the reference number ISO/CEI 11172), which aims at applications of storing digital audiovisual data,

MPEG-2 (bearing the reference number ISO/CEI 13818), which is intended particularly for the distribution of television programs, and

MPEG-4 (bearing the reference number ISO/CEI 14496), which is dedicated to interactive uses in the management of multimedia data.

Although these standards aim at different purposes they are all based on a block encoding technique, using the temporal and spatial redundancies which exist within a sequence of pictures. In order to eliminate spatial redundancies a discrete cosine transform DCT is applied to blocks of 8 lines of 8 samples of the video signal.

As far as the temporal redundancies are concerned, three types of pictures using different encoding methods are defined in the MPEG standards:

intra-coded or I pictures are encoded by means of information derived from the pictures themselves only; they serve to facilitate random access to the sequence;

predictive-coded or P pictures are encoded by motion compensation prediction on the basis of a past I or P reference picture in the display order;

bidirectionally predictive-coded or B pictures are encoded by motion-compensation prediction on the basis of a past or future I or P reference picture.

The MPEG standards comprise a motion compensation process based on the detection of the displacement of the picture to be encoded including minimization of the error with respect to a preceding picture. Whereas the encoding unit by means of which the spatial redundancies can be reduced is the block, the motion compensation uses macroblocks, a macroblock being a group of 4 luminance blocks and 2, 4 or 8 chrominance blocks in accordance with the chrominance formats 4:2:0, 4:2:2, or 4:4:4, respectively, the blocks stemming from a sector of 16×16 elements of the luminance component of the picture.

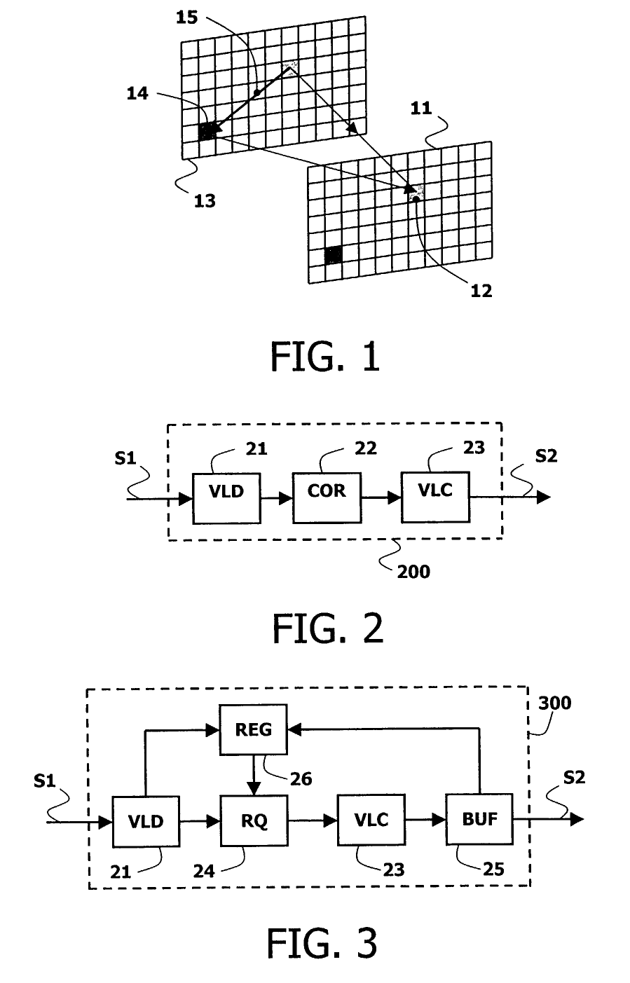

A motion estimation process, described with reference to FIG. 1, first attempts to map a macroblock (12) of the current picture (11) onto a macroblock of the preceding picture. Once the most probable position (14) of the macroblock in the preceding picture (13) has been found, a displacement vector (15) associated with the macroblock of the current picture is determined. Subsequently, the predicted macroblock, which corresponds to the difference between the current macroblock and the most probable macroblock, and the associated motion vector are encoded.

Various prediction methods are possible, the picture type defining the prediction method that can be used for encoding each macroblock. For example, a macroblock may be forward predicted on the basis of a reference macroblock belonging to a past picture and it may also be backward predicted on the basis of a reference macroblock belonging to a future picture in the display sequence. Another option is to apply no prediction in such a manner that the blocks of the macroblock of the current picture are encoded directly. These macroblocks are referred to as intra macroblocks.

It is an object of the present invention to provide a method of converting a binary stream of input data encoded in accordance with a first format of a block encoding technique into a binary stream of output data, which is compatible with a second format of said technique. The invention takes into account the following aspects.

The second format of the block encoding technique may include encoding parameters which differ from those in the first format of this technique. For example, the MPEG 4 format differs from the MPEG 1 and 2 formats in that it does not allow intra macroblocks in a bidirectionally predictive-coded B picture. If no modification is made a binary data stream encoded in accordance with the MPEG 1 or MPEG 2 standard including such macroblocks will not be a binary stream that is compatible with the MPEG 4 standard and can therefore not be decoded by an MPEG 4 decoder.

In order to preclude this problem the conversion method in accordance with the present invention is characterized in that it comprises a step of replacing intra macroblocks of a B picture belonging to the binary input stream with predicted macroblocks, thus forming the binary output stream.

Thus, the method ensures a correct conversion of the binary input stream and the resulting binary output stream will include information which is identifiable by an MPEG 4 decoder.

The replacement of an intra macroblock of a B picture by a predicted macroblock can be achieved in a plurality of different manners.

In a first variant the replacement step comprises:

a substep of storing a group of intra macroblocks for an intra-coded I picture or a predictive-coded P picture,

a substep of determining, for an intra macroblock belonging to a B picture, a reference macroblock from the group of macroblocks thus stored for the I or P picture which precedes or follows the B picture in the display order,

a substep of calculating the predicted macroblock on the basis of the intra macroblock and the reference macroblock.

Such a conversion method uses intra macroblocks of I or P pictures which precede or follow the B picture in the display order, such macroblocks, in contradistinction to macroblocks of other types, requiring no reconstruction process because they have been encoded without any reference to other macroblocks. Thus, this method makes it possible to determine a predicted macroblock in a simple and effective manner, from the intra macroblock and the reference macroblock.

In another variant the replacement step comprises:

a substep of adding a group of additional macroblocks to a picture,

a substep of determining, for an intra macroblock belonging to a B picture, a reference macroblock from the group of additional macroblocks for the intra-coded I picture or the predictive-coded P picture which precedes or follows the B picture in the display order, and

a substep of calculating the predicted macroblock on the basis of the intra macroblock and the reference macroblock.

This second variant makes it possible to determine a reference macroblock when there is no intra macroblock in the P pictures which precede or follow the B picture, while the amount of additional information to be encoded is minimized.

These aspects of the invention as well as other more detailed aspects will become apparent from the following description of several methods of realizing the invention, given by way of non-limitative example with reference to the accompanying drawings, in which:

FIG. 1 represents a prior-art motion estimation process,

FIG. 2 is a diagram which illustrates a first mode of operation of the conversion method in accordance with the invention,

FIG. 3 is a diagram which illustrates a second mode of operation of the conversion method in accordance with the invention, and

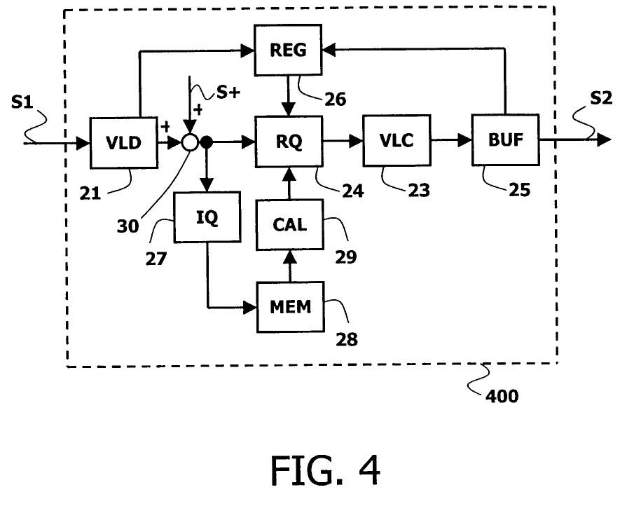

FIG. 4 is a diagram which illustrates a third mode of operation of the conversion method in accordance with the invention.

The present invention relates to a method of converting a binary input stream of data encoded in accordance with a first format of a block encoding technique into a binary output stream of data encoded in accordance with a second format of the encoding technique. It has been developed more specifically within the scope of the conversion of a binary input stream encoded in accordance with the MPEG 1 standard into a binary output stream encoded in accordance with the MPEG 4 standard but it can nevertheless be applied wholly or partly to the conversion of other video encoding standards utilizing a block encoding technique such as, for example, MPEG 2, H.261 or H.263, if the conversion conditions are similar.

The present invention has the advantage that complete decoding is avoided, i.e. including a reconstruction of the decoded picture, in accordance with the first format of a block encoding technique followed by re-encoding in accordance with the second format of said technique. Its goal is to minimize the operations involved even in partial decoding and re-encoding of said streams, such as for example the re-quantization of the encoded data. This method enables a user to utilize pictures encoded in accordance with the MPEG format again in an MPEG 4 application, such as for example video telephony, in a simple manner.

FIGS. 2 to 4 show three modes of operation (200, 300 and 400) of the conversion method, namely a simple transcription of the input stream, a conversion with re-quantization of the input stream, and a conversion with partial decoding of certain macroblocks of said stream.

FIG. 2 is a diagram which illustrates the first mode of operation of the conversion method in accordance with the invention. Said method comprises the steps of:

variable-length decoding VLD (21) the binary input stream (S1) in order to provide decoded data comprising, for example, for each macroblock, quantized DCT coefficients ac_{q}, the corresponding quantization step or scale q, a prediction mode and a motion vector,

correcting COR (22) the decoded data, and

variable-length encoding VLC (23) the corrected decoded data in order to provide the binary output stream (S2).

The correction step proves to be necessary in, for example, the following cases.

The MPEG 4 standard does not know or does not allow all the functionalities permitted by the MPEG 1 and even the MPEG 2 standard. It does not process, for example, the pictures in accordance with their screen display number NUMi but in accordance with their display time Ti. For this purpose, the correction step translates the screen display number of an picture of the MPEG 1 binary input stream into a display time for the MPEG 4 binary output stream, which is effected on the basis of the known rate R of the binary input stream: Ti=NUMi×R. This operation is a simple transcription operation, which does not require any requantization of quantized DCT coefficients.

The MPEG 1 and MPEG 2 standards enable the quantization step Qslice for a slice of consecutive macroblocks belonging to a row of macroblocks of the picture to be determined, Qslice being specified once and for all at the beginning of the slice. The MPEG 4 standard does not know the concept of “slice”. That is why the correct step in accordance with the present invention assigns a quantization step Qslice to all the macroblocks belonging to the slice. In fact, the MPEG 4 standard transmits differences in quantization steps: the quantization step Qslice is thus assigned to the first macroblock belonging to the slice and the value 0 is assigned to the following macroblocks in order to form the binary output stream.

FIG. 3 is a diagram which illustrates the second mode of operation of the conversion method in accordance with the invention. Said method comprises the steps of:

variable-length decoding VLD (21) the binary input stream (S1) in order to provide decoded data comprising, for example, for each macroblock, quantized DCT coefficients ac_{q}, the corresponding quantization step q, a prediction mode and a motion vector,

requantizating RQ (24) quantized DCT coefficients ac_{q} with a modified quantization step q′, yielding modified DCT coefficients ac_{q}′,

variable-length encoding VLC (23) the data after requantization in order to provide the binary output stream (S2),

storing BUF (25) the data thus encoded into a buffer memory, and

controlling REG (26) so as to enable the input and output of the buffer memory to be controlled by changing the value of the modified quantization step q′.

The requantization step proves to be necessary in the following cases.

The MPEG 1 and MPEG 2 standards provide the possibility of varying the quantization step from one macroblock to the following macroblock in accordance with a range of given values without the variation of the quantization step being limited within this range. The MPEG 4 standard itself limits the variation of the quantization step to +/−2. If the variation of the quantization step from one macroblock to the next macroblock is greater than 2 in absolute value for the binary input stream the requantization step will limit this variation to 2. The requantization step can be refined by storing in advance the quantization steps corresponding to one group of macroblocks of the binary input stream, for example to one row of the picture, and by determining the best variations of the quantization step for this group of macroblocks. In the preferred variant the curve of the modified quantization steps q′ is determined by quadratic minimization starting from the quantization steps stored for one row, taking into account variations of the modified quantization step q′ limited to +/−2.

The DC coefficients (i.e. the DCT coefficients for which the frequency is zero in the two dimensions) of the intra encoded blocks should be subjected to an inverse quantization in accordance with a method which differs from all the other coefficients. In the MPEG 1 standard the result of the inverse quantization is the DC coefficient multiplied by a multiplication factor equal to 8. In the MPEG 4 standard, the multiplication factor, referred to as dc_scaler, is variable and is a function of the quantization step in accordance with a table defined by this standard. The step of requantization consequently replaces the multiplication factor equal to 8 of the binary input stream by the value dc_scaler defined in the table, starting from the initial quantization step q or the modified quantization step q′, as the case may be.

This step of requantization may considerably change the rate of the binary output stream. In the case of a variable-rate stream this change will not have any effect. Conversely, in the case of a constant rate or a rate which varies within a range of given values, a control step which changes the value of the modified quantization step q′ is needed in order to avoid any overflow of the buffer memory.

As in fact mentioned hereinbefore, the MPEG 4 standard does not allow intra macroblocks in a B picture (pp. 337-338 of the standard ISO/CEI 14496-2, 1999). That is why the conversion method in accordance with the invention also includes a step of replacing intra macroblocks B by predicted macroblocks.

FIG. 4 is a diagram which illustrates this mode of operation of the conversion method. In a first variant said method further includes, in addition to the steps described in the preceding paragraph, the following steps of:

inversely quantizating IQ (27) quantized DCT coefficients acB_{q} for an intra macroblock belonging to a B picture and acI_{q}(i) for a group of i intra macroblocks belonging to an I picture, or acP_{q}(j) for a group of j intra macroblocks belonging to a P picture,

storing ME (28) inversely quantized macroblocks containing the coefficients acB, acI(i) and acP(j) for the B, I and P pictures, respectively,

calculating CAL (29), for the intra macroblock of a B picture, a reference macroblock in an I or P picture preceding or following the B picture in the display order and subsequently a macroblock predicted on the basis of the intra macroblock and of the reference macroblock.

The group of macroblocks in which the reference macroblock is searched for is formed by all the intra macroblocks present in an I or P picture. In accordance with the available memory resources, the group of macroblocks may be limited to certain macroblocks present in an I or P picture and spread within said picture.

The group of macroblocks is stored in the memory MEM, while a macroblock of the I or P picture can serve as a reference for the intra macroblock of the current B picture.

The step of calculating the reference macroblock is performed taking into account the following parameters:

the value of a prediction error calculated on the basis of the current intra macroblock of the B picture and of a stored macroblock; in this case a minimum value of the prediction error is searched. The prediction error for a macroblock k of the group of macroblocks is, for example, equal to the absolute value of the difference between the coefficients acB and acp(k) for a P picture or acI(k) for an I picture. In another example it is equal to the sum of the square of the difference of said coefficients for one macroblock.

the position of a stored macroblock in the P picture with respect to that of the intra macroblock of the B picture. Actually, if the stored macroblock is situated very far from the intra macroblock of the B picture the number of bits required to encode the corresponding motion vector may be substantial, which consequently reduces the coding efficiency. A stored macroblock associated with a motion vector whose value is outside a range of given values, for example [−128, 127], is thus excluded from the search area of the reference macroblock. In this case, the reference macroblock will not necessarily be that one whose prediction error will be the smallest among all the stored macroblocks but that one whose prediction error is the smallest of the stored macroblocks belonging to a search window.

The predicted macroblock is thus determined on the basis of the difference between the current intra macroblock of the B picture and the reference macroblock found, while the associated motion vector is determined on the basis of the respective positions of the macroblocks in the picture.

In the preferred variant, the calculation of the prediction error is performed on the basis of inversely quantized macroblocks. It is likewise possible to convert them into macroblocks of pixels with the aid of an inverse discrete cosine transform IDCT. This constitutes a classic motion estimation situation. However, an IDCT transform may be costly in terms of calculation time, which is why the preceding solution is to be preferred. Moreover, owing to the conservation of energy in the DCT domain the sum of the squares of the errors in the DCT domain and the sum of the squares of the errors in the pixel domain are equal, as a result of which these two methods are equivalent in this specific case.

However, a problem arises when a reference macroblock is to be determined if there is no intra macroblock in the P pictures which precede or follow the B picture. This is why the method further includes a step of adding (30) a group of additional macroblocks (S+) to the pictures of the sequence. For this purpose, it is possible to change the size of the pictures by specifying it in the header field of said picture. In the preferred variant, the conversion method adds a row of macroblocks at the bottom of the picture. It is likewise possible to add this row to the top of the picture or to add a column to the right or to the left of the picture. Since the size of the picture is changed these additional macroblocks are added for all the pictures of the sequence.

The calculation step thus determines for an intra macroblock of a B picture:

a reference macroblock in the group of additional macroblocks for the I or P picture which precedes or follows the B picture in the display order, and

a macroblock predicted on the basis of intra and reference macroblocks using the same principle as described hereinbefore.

The group of additional macroblocks includes, for example, a logo or rather data having identical values. In the last-mentioned case the additional information is encoded with the minimum of bits. For I pictures these macroblocks are intra encoded; for P and B pictures the additional macroblocks are forward predicted in that they are associated with a zero prediction error and a zero motion vector. In order to minimize the motion vector the reference macroblock is chosen in the same column as the current macroblock of the B picture. This reference macroblock does not correspond to an intra macroblock in the P picture but since the data it contains have not changed in the P picture, it corresponds to that of the preceding I picture. Thus, the predicted macroblock is calculated on the basis of the error between the current intra macroblock of the B picture and the intra macroblock of the I picture. If the additional macroblocks of the I pictures contain data equal to zero the DCT coefficients of the predicted macroblock are those of the current intra macroblock acB_{q}.

In a modification of the preceding method the intra macroblock of the B picture is replaced with a predicted macroblock containing DCT coefficients which are zero and which are associated with a zero motion vector. This method requires only one correction step (22) such as described with reference to FIG. 2. As a result of this, the macroblock of the P picture which precedes or follows the B picture is frozen. However, the visual result may be annoying to the user.

As in the mode of operation illustrated in FIG. 3, requantization and control steps may appear to be necessary, respectively in order to allow for the quantization step variations imposed by the MPEG 4 standard and in order to control the rate of the binary output stream.

The above description with reference to FIGS. 2 to 4 illustrates rather than limits the invention. It is evident that there are other alternatives within the scope of the appended claims.

There are numerous ways of implementing the described functions by means of software. In this respect, it is to be noted that FIGS. 2 to 4 are highly diagrammatic, each Figure representing merely a single variant. Thus, although a Figure shows different functions as separate blocks, this does not exclude the possibility that a single item of software performs a plurality of functions. This by no means excludes the possibility that a function may be carried out by a group of software items.

These functions may be implemented in a computer or a set top box by means of a circuit suitably programmed. A group of instructions contained in a program memory can cause the circuit to carry out the different operations described hereinbefore with reference to FIGS. 2-4. The group of instructions can be loaded into the program memory by reading a data carrier, such as for example a disc which carries the group of instructions. Reading may also be effected via a communication network such as, for example, the internet. In this case, a service provider will make the group of instructions available to those interested.

Any reference signs given in parentheses in a claim shall not be construed as limiting said claim. The use of the verb “to comprise” does not exclude the presence of any elements or steps other than those defined in a claim. The use of the indefinite article “a” or “an” preceding an element or step does not exclude the presence of a plurality of these elements or these steps.

1. A method of converting a binary input stream of data encoded in accordance with a first format of a block-based encoding technique, the binary input stream comprising pictures, into a binary output stream of data encoded in accordance with a second format of the encoding technique, said method comprising a step of replacing of a set of non-reference encoded blocks, hereinafter referred to as intra macroblock, of a bidirectionally predictive-coded B picture belonging to the binary input stream, with a set of reference encoded blocks, hereinafter referred to as predicted macroblock, thus forming the binary output stream.

2. A conversion method as claimed in claim 1, in which the replacement step comprises:
a substep of storing a group of intra macroblocks for an intra-coded I picture or a predictive-coded P picture,
a substep of determining, for an intra macroblock belonging to a B picture, a reference macroblock from the group of macroblocks thus stored for the I or P picture which precedes or follows the B picture in the display order, and
a substep of calculating the predicted macroblock on the basis of the intra and reference macroblocks.

3. A conversion method as claimed in claim 2, in which the substep of determining is adapted to determine the reference macroblock as a function of the value of a prediction error calculated on the basis of the intra macroblock of the B picture and of a stored macroblock.

4. A conversion method as claimed in claim 1, in which the replacement step comprises:
a substep of adding a group of additional macroblocks to a picture,
a substep of determining, for an intra macroblock belonging to a B picture, a reference macroblock from the group of additional macroblocks for the intra-coded I picture or the predictive-coded P picture which precedes or follows the B picture in the display order, and
a substep of calculating the predicted macroblock on the basis of the intra and reference macroblocks.

5. A conversion method as claimed in claim 4, in which the group of additional macroblocks contains data having identical values.

6. A conversion method as claimed in claim 2 or 4, in which the substep of determining is adapted to determine the reference macroblock as a function of its position in the P picture with respect to that of the intra macroblock of the B picture.

7. A conversion method as claimed in claim 1, in which the replacement step is adapted to replace the intra macroblock by a predicted macroblock containing DCT coefficients which are zero and which are associated with a zero motion vector.

8. A computer program product for a computer comprising a set of instructions, which, when loaded into a circuit of said computer, causes the computer circuit to carry out the method as claimed in claim 1 to 7.

9. A computer program product for a set-top-box comprising a set of instructions, which, when loaded into a circuit of said set-top-box, causes the set-top-box circuit to carry out the method as claimed in claim 1 to 7.
